(19) United States
(12) Patent Application Publication
(10) Pub. No.: US 2025/0216673 A1
(43) Pub. Date: Jul. 3, 2025

(54) DISPLAY DEVICE, DISPLAY METHOD, AND RECORDING MEDIUM

(71) Applicant: Panasonic Automotive Systems Co., Ltd., Kanagawa (JP)

(72) Inventors: Masanaga TSUJI, Osaka (JP); Fumihito INUKAI, Kyoto (JP); Toshiya MORI, Osaka (JP)

(73) Assignee: Panasonic Automotive Systems Co., Ltd., Kanagawa (JP)

(21) Appl. No.: 18/979,133

(22) Filed: Dec. 12, 2024

(30) Foreign Application Priority Data
Dec. 28, 2023 (JP) 2023-223511

(51) Int. Cl. G02B 27/01; G09G 3/00

(52) U.S. Cl. CPC G02B 27/0101; G09G 3/002; G09G 2320/0626; G09G 2320/0666; G09G 2340/045; G09G 2340/0464; G09G 2380/10

(57) ABSTRACT

A display device forms a virtual image of an image visible to a user in a predetermined region in an outside world by projecting the image within a predetermined angle of view (display region) of a display medium through which the outside world is viewable, the predetermined region corresponding to the predetermined angle of view. The display device includes: a projector that projects light showing the image onto the display medium; an obtainer (first obtainer) that obtains a superimposition distance that is a distance from the user to a position at which the virtual image of the image is formed; and a controller that, when an original projection position of the image is outside the predetermined angle of view, changes the original projection position of the image by an amount of change corresponding to the superimposition distance and causes the projector to project the image.

### CROSS REFERENCE TO RELATED APPLICATION

The present application is based on and claims priority of Japanese Patent Application No. 2023-223511 filed on Dec. 28, 2023.

### FIELD

The present disclosure relates to a display device and a display method for displaying an image to a user, and a recording medium for executing the display method.

### BACKGROUND

Conventionally, a display device that reflects light for projecting an image onto a display medium that transmits light from the outside world to allow a user to view a virtual image superimposed on the outside world has been known. For example, as one of such display devices in a vehicle, a head-up display (hereinafter also referred to as “HUD”) has been put into practical use. In addition, it is possible to change the superimposed position according to the height of the viewpoint of a driver, the user of a vehicle (for example, see Patent Literature (PTL) 1).

### CITATION LIST

### Patent Literature

PTL 1: International Patent Application Publication No. WO 2016/067574

### SUMMARY

However, the technique disclosed in PTL 1 can be improved upon. In view of this, the present disclosure provides a display device and so on capable of improving upon the above related art.

In order to solve the aforementioned issue, a display device according to one aspect of the present disclosure is a display device that forms a virtual image of an image visible to a user in a predetermined region in an outside world by projecting the image within a predetermined angle of view of a display medium through which the outside world is viewable, the predetermined region corresponding to the predetermined angle of view. The display device includes: a projector that projects light showing the image onto the display medium; an obtainer that obtains a superimposition distance that is a distance from the user to a position at which the virtual image of the image is formed; and a controller that, when an original projection position of the image is outside the predetermined angle of view, changes the original projection position of the image by an amount of change corresponding to the superimposition distance and causes the projector to project the image.

In addition, a display method according to one aspect of the present disclosure is a display method to be executed by a computer and for forming a virtual image of an image visible to a user in a predetermined region in an outside world by projecting the image within a predetermined angle of view of a display medium through which the outside world is viewable, the predetermined region corresponding to the predetermined angle of view, the display method includes: projecting light showing the image onto the display medium; obtaining a superimposition distance that is a distance from the user to a position at which the virtual image of the image is formed; and changing, when an original projection position of the image is outside the predetermined angle of view, the original projection position of the image by an amount of change corresponding to the superimposition distance.

Moreover, a recording medium according to one aspect of the present disclosure is a non-transitory computer-readable recording medium having recorded thereon a program for causing a computer to execute the display method described above.

A display device and so on according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating an application example of a display device according to an embodiment.

FIG. 2 is a block diagram illustrating a functional configuration of the display device according to the embodiment.

FIG. 3 includes schematic diagrams for illustrating display control on images according to the embodiment.

FIG. 4 is a flowchart illustrating a display method according to the embodiment.

FIG. 5 is a diagram for illustrating display control on an image according to the embodiment.

FIG. 6 is a diagram for illustrating display control on images according to the embodiment.

FIG. 7 is a diagram for illustrating display control on images according to the embodiment.

FIG. 8 is a diagram for illustrating display control on images according to the embodiment.

FIG. 9 is a diagram for illustrating display control on images according to the embodiment.

FIG. 10 is a diagram for illustrating display control on images according to the embodiment.

FIG. 11 is a diagram for illustrating display control on images according to the embodiment.

FIG. 12 is a diagram for illustrating display control on images according to the embodiment.

### DESCRIPTION OF EMBODIMENT

### Underlying Knowledge Leading to the Present Disclosure

The inventors found that the following issues arose with respect to the technique described in the “Background” section. When the technique disclosed in PTL 1 is applied to a display device, it may be difficult to display an appropriate image. More specifically, a display device, such as a HUD, provided in a vehicle, is a device that displays various information about the vehicle using images (e.g., visual information including numbers, letters, and graphics such as arrows) to a user such as a driver who operates the vehicle.

As the information displayed by the display device includes various kinds of information. For example, information displayed on the instrument panel such as a driving status of a motor or a powertrain of the internal combustion engine, etc., the traveling speed, droplet temperatures, a voltage supplied to electrical components, pressurization of the compressor; warning information based on the relationship with the vehicle's surroundings, such as lane crossing, overspeeding, and start of a forward vehicle; route information such as travel time remaining until the destination, direction, distance, and the traveling direction (for example, turn-by-turn) on the traveling route; traffic sign information such as speed limits on the traveling road, prohibition of parking and stopping, and lane regulations; and terminal information through an information terminal carried by a user, such as telephone calls, e-mails, notifications from specific applications, etc. In addition, the image displayed by the display device need not be an image related to the vehicle. For example, the display device may be used to display a user's favorite picture, moving image, or information on an Internet site, etc.

In particular, for example, the HUD projects an image onto a display medium, such as a windshield and a combiner, located in front of the driver's seat of the vehicle, reflects the image onto the display medium, and forms a virtual image visible to the user at a greater distance (ahead of a vehicle, etc.) than the display medium seen by the user. In this case, because the display medium has light transmittance (also expressed as being transparent to light), the light that enters from outside the display medium is superimposed on the virtual image as a scenery and so on of the outside world and is visible to the user.

Here, by constructing the HUD using the technique disclosed in PTL 1, a predetermined angle of view in which the image is displayed can be appropriately set according to the sitting conditions of the user (sitting height of the user and set sitting height). On the other hand, when the sitting conditions and such a predetermined angle of view are set, part of the image (especially the part in the up-and-down direction corresponding to the viewpoint height of the user) may be cut off. In view of this, the present disclosure adjusts the image such that part of the image that may be cut off as described above is displayed within the predetermined angle of view. However, by simply adjusting the image to fit within a predetermined angle of view, it may not be possible to distinguish between an image that has been cut off at a superimposition distance of 25 m and an image that has been cut off at a superimposition distance of 40 m, for example. In other words, there is a possibility that adjustment is made in a manner that the information of the superimposition distance would be lost. On the other hand, when performing image adjustment, the present disclosure changes the projection position by an amount of change according to the original superimposition distance. This makes it possible to read the information of the superimposition distance from the projection position because the amount of change corresponds to the original superimposition distance. In other words, it is possible to maintain information that would be lost due to adjustments performed when an image is displayed within a predetermined angle of view. Therefore, it is possible to display an image more appropriately in terms of addressing the loss of information.

The following describes an embodiment of the present disclosure with reference to the drawings. Note that the embodiment described below shows a general or specific example of the present disclosure. Therefore, the numerical values, structural elements, the arrangement and connection of the structural elements, steps and the order of the steps, etc. mentioned in the following embodiment are mere examples and not intended to limit the present disclosure. Therefore, among the structural elements in the following embodiment, structural elements not recited in any one of the independent claims representing broadest concepts of the present disclosure are described as optional structural elements.

In addition, each diagram is a schematic diagram and is not necessarily a precise illustration. Accordingly, scaling is not necessarily consistent throughout the drawings. In each figure, configurations that are essentially the same share like reference signs. Accordingly, duplicate description is omitted or simplified.

### Embodiment

### Display Device

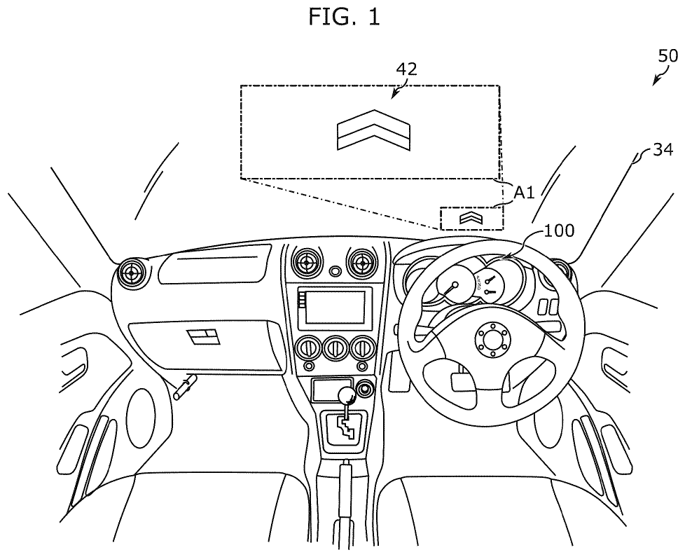

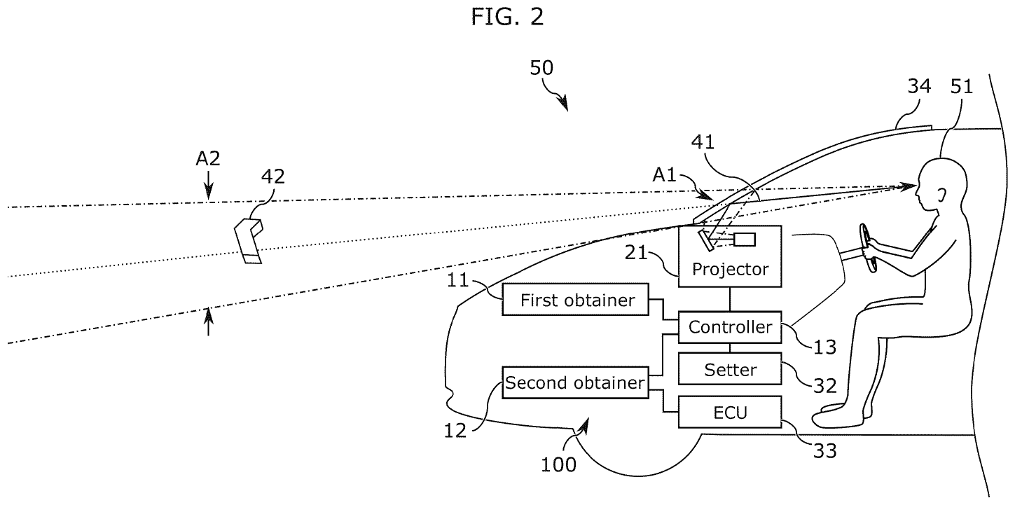

First, an overview of a display device according to an embodiment will be described. FIG. 1 is a diagram illustrating an application example of the display device according to the embodiment. FIG. 1 illustrates the passenger compartment of vehicle 50, which is an example of a mobile body equipped with display device 100. Moreover, display device 100 is disposed inside the instrument panel of vehicle 50 and is not visible to user 51 (see FIG. 2, which will be described later). Accordingly, since the interior of vehicle 50 can be freely designed, it is possible to provide display device 100 without compromising the design of vehicle 50.

Display device 100 makes virtual image 42 visible to user 51 using image 41 (see FIG. 2, which will be described later) reflected through the windshield, which is display medium 34. Note that, here, virtual image 42 is displayed in the seating layout assuming that the driver of vehicle 50 is user 51, but user 51 may be a passenger seated in, for example, a passenger seat or a rear seat of vehicle 50. Therefore, display medium 34 may also be implemented as a side window, a rear window, a roof window, etc., according to user 51.

FIG. 2 illustrates a situation in which virtual image 42 formed through display region A1 of the windshield in front of the driver, who is user 51, is visible to user 51. In display device 100 illustrated in FIG. 1, image 41 displayed as virtual image 42 includes an arrow indicating the traveling direction of vehicle 50. Note that, FIG. 1 illustrates an enlarged view of an image displayed in display region A1 for the sake of legibility, and the corresponding corners are connected by dash-dotted lines.

Next, each functional component included in display device 100, and the relationship between virtual image 42 to be formed and image 41 will be described. FIG. 2 is a block diagram illustrating a functional configuration of the display device according to the embodiment. FIG. 2 is a plan view of a plane taken along the front-and-rear direction and the height direction of vehicle 50, and the image of user 51 seen through the passenger compartment is illustrated.

As illustrated in FIG. 2, display device 100 according to the present embodiment includes first obtainer 11, second obtainer 12, controller 13, projector 21, and setter 32 that receives input of various settings in the display of image 41 that has been adjusted. Note that, although the details will be described later, setter 32 is a configuration required to implement an additional function of display device 100. If this function is not required, display device 100 can be implemented without setter 32. In other words, setter 32 is not an essential structural element of display device 100.

First obtainer 11 is an example of the obtainer and is a functional component that obtains a source image used to generate image 41 that has been adjusted. Hereinafter, the source image may be simply expressed as the original image. First obtainer 11 is, for example, a processing device that obtains the original image generated from a generation device (not illustrated) that generates an original image. First obtainer 11 is implemented by executing, by a circuit such as a processor and a storage device such as memory, a program that obtains the above-described original image. First obtainer 11 can also be regarded as a communication module that simply obtains the original image via communication and transmits the obtained original image to controller 13.

Note that, the original image may be directly generated by first obtainer 11 when first obtainer 11 serves the function of the above-mentioned generation device. The original image is constructed based on various information about vehicle 50. Therefore, when the original image is directly generated, first obtainer 11 is connected to an external device such as electronic control unit (ECU) 33 and a navigation system (not illustrated), and obtains information from the external device to generate the original image.

The original image obtained by first obtainer 11 includes information about a superimposition distance, which is a distance to the position where a virtual image is formed if the original image is projected as it is. In other words, if the original image obtained by first obtainer 11 is projected as it is, a virtual image is projected such that the virtual image is formed at the position of the superimposition distance included in the original image. Note that, the original image and the superimposition distance may be obtained by different obtainers.

Second obtainer 12 is a functional component that obtains a driving situation of vehicle 50. Second obtainer 12 obtains, for example, the state and a traveling scene of vehicle 50 as the driving situation. The state of vehicle 50 is obtained from a control device used to control the travel, operation, and functions of vehicle 50, such as ECU 33. Second obtainer 12 is implemented by executing, by a circuit such as a processor and a storage device such as memory, a program that obtains the above-described driving situation. Second obtainer 12 can also be regarded as a communication module that simply obtains the driving situation via communication and transmits the obtained driving situation to controller 13.

Note that, the traveling scene of vehicle 50 is obtained by generating a traveling scene from information obtained from the navigation system, imager 31, ECU 33, etc. The state and traveling scene of vehicle 50 may be obtained by generating the state and the traveling scene by second obtainer 12, or generating the state and the traveling scene by a generation device (not illustrated) provided separately from second obtainer 12 and the generated state and traveling scene may be obtained by second obtainer 12.

Controller 13 is a functional component that corrects the original image obtained by first obtainer 11 based on the superimposition distance obtained by first obtainer 11 to generate a corrected image 41. Controller 13 is implemented by executing, by a circuit such as a processor and a storage device such as memory, a program for adjusting the above-described original image. Controller 13 adjusts the image by also using the driving situation obtained by second obtainer 12. The image processing by controller 13 will be described later in detail.

The aforementioned first obtainer 11, second obtainer 12, and controller 13 together can be regarded as a display control device that generates image 41 for appropriate display. As described above, a display control device is implemented in practice as a computer that includes a circuit such as a processor and a storage device such as memory. First obtainer 11, second obtainer 12, and controller 13 may be integrated into the display control device. Moreover, the circuits and storage devices that implement each functional component in the display control device may be provided for each functional component, may be shared by multiple functional components, or may be one circuit and one storage device that implements all the functional components.

Projector 21 projects the generated image 41 onto display medium 34 and forms virtual image 42 of image 41 in predetermined region A2 in the outside world. Projector 21 includes a light source, and light corresponding to image 41 is emitted from the light source. Moreover, projector 21 includes an optical system in which optical elements such as mirrors and lenses are combined. Projector 21 causes the light to reflect off display medium 34 through the optical system, and emits the light of image 41 along the optical path connecting display region A1 in display medium 34 and the eyes of user 51. The emitted light of image 41 is reflected off display medium 34 and enters the eyes of user 51, as illustrated by the solid arrow in FIG. 2. From user 51, the light of image 41 appears to be virtual image 42 of image 41 in the background of display medium 34 (i.e., the side where the outside world is located).

In other words, virtual image 42 of image 41 is formed beyond display medium 34 on the side where the outside world is located. The region in which this virtual image 42 is formed is predetermined region A2 described above. Predetermined region A2 is the region illustrated with dash-dotted lines in FIG. 2 and corresponds to the predetermined angle of view. Predetermined region A2 is defined by straight lines connecting the eyes of user 51 and points on display region A1. Since display region A1 has a range formed by a plurality of points, predetermined region A2 varies according to the design of display medium 34 and projector 21, as illustrated in the figure. In other words, display region A1 can be set in any manner by the design of display medium 34 and projector 21.

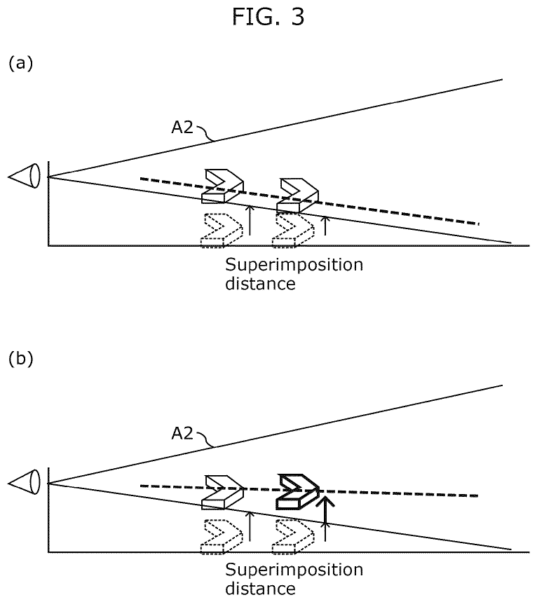

Here, if the original image is projected as it is, for example, the situations as illustrated in FIG. 3 may arise. FIG. 3 includes schematic diagrams for illustrating display control on images according to the embodiment. In (a) in FIG. 3, the images displayed outside predetermined region A2 (i.e., outside the predetermined angle of view) are illustrated by dashed lines. As illustrated in the figure, if images are projected such that virtual images 42 are formed outside predetermined region A2, their light does not enter the eyes of the user, and virtual images 42 are not visible to the user. On the other hand, if images 41 are generated by adjusting the original image such that images 41 are projected simply in predetermined region A2, virtual images 42 will appear as the images illustrated by the solid lines in the figure. At this time, since the two images with different superimposition distances overlap at the bottom edge of predetermined region A2 as illustrated by the dashed line, the sense of perspective will be lost and the information of the superimposition distances will be lost.

In the present embodiment, as illustrated in (b) in FIG. 3, when the original image is adjusted to generate image 41, the amount of change in projection position at the time of adjustment is different between an image with a short superimposition distance (the left image illustrated by solid lines) and an image with a long superimposition distance (the right image illustrated by solid lines). Specifically, as illustrated in the figure, how high the images are to be projected from the bottom edge of predetermined region A2 in the up-and-down direction, an image with a short superimposition distance is adjusted to be projected at a position where the distance from the bottom edge is zero, and an image having a longer superimposition distance is adjusted to be projected at a position where the distance from the bottom edge is further upward, as illustrated by the thick arrow pointing from the bottom edge. As a result, the difference in the superimposition distance can be perceived by user 51 according to the distance in the up-and-down direction from the bottom edge (deviation distance, which will be described later).

The height (Hc) at which virtual image 42 is displayed and the amount of change from the superimposition distance are calculated based on Equation (1) below.

$$Hc = He - Lc \times tan ( θ L ) + Oc + K \times Lc - C \qquad ( 1 )$$

In Equation (1) above, He denotes the viewpoint height of user 51, Lc denotes the superimposition distance set for the original image, θL denotes the depression angle of the lower edge of predetermined region A2 with respect to the horizontal direction, Oc denotes the offset height, K denotes an adjustment coefficient, and C denotes an adjustment intercept. The offset height (Oc) is a numerical value for actually moving the projection position of an original image from the lower edge of predetermined region A2 to an upper side when the size, etc. of the original image are taken into account. The part “He−Lc×tan(θL)+Oc” in Equation (1) above can be said to be a minimum display height of a virtual image when an original image is projected at the bottom edge of predetermined region A2. In the present embodiment, the projection position of the original image is changed in the height direction by the amount of change that correlates with the superimposition distance (Lc) set for the original image by the part “K×Lc−C”. In this way, the superimposition distance (Lc) set for the original image can be visually recognized by user 51 as the height of the projection position. Note that an appropriate value for each variable in Equation (1) differs depending on various conditions, such as the size of the original image and the size of predetermined region A2. Therefore, an appropriate value should be set empirically or experimentally by, for example, user 51 or the manufacturer of display device 100. Moreover, Oc+K×Lc−C, in which the offset height (Oc) is added to the part “K×Lc−C”, is sometimes expressed as the deviation distance indicating the degree of deviation from the lower edge of predetermined region A2. The deviation distance is a function proportional to the superimposition distance (Lc), as indicated by the equation. In other words, the deviation distance is a distance corresponding to the superimposition distance.

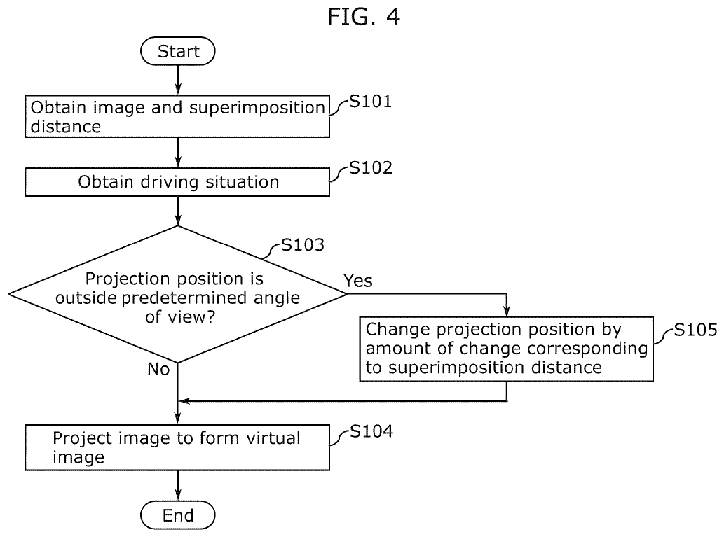

In the following, an example of the operation of display device 100 and other image processing in the present embodiment will be described with reference to FIGS. 4 to 12. First, with reference to FIG. 4, a display method corresponding to the example of the operation of display device 100 described above will be described. FIG. 4 is a flowchart illustrating the display method according to the embodiment.

As illustrated in FIG. 4, in the present embodiment, first obtainer 11 obtains an original image and its associated superimposition distance (first obtaining step S101). First obtainer 11 transmits the obtained original image to controller 13. First obtaining step S101 is performed successively, and original images are successively transmitted to controller 13.

Moreover, second obtainer 12 obtains a driving situation from an external device such as ECU 33 (second obtaining step S102). Second obtainer 12 transmits the obtained driving situation to controller 13. Second obtaining step S102 is also performed successively, and driving situations are successively transmitted to controller 13 as with the original images.

Here, controller 13 generates images 41 according to the original images and the driving situations that have been transmitted successively. Here, when it is determined that an original image needs to be adjusted based on the associated superimposition distance, the original image is adjusted and image 41 is generated. Specifically, controller 13 determines whether the projection position of an original image is outside the predetermined angle of view, i.e., whether a virtual image to be formed is outside predetermined region A2, if the original image is projected (step S103). When the projection position of the original image is not outside the predetermined angle of view, i.e., the projection position is within the predetermined angle of view, if the original image is projected (No in step S103), the original image is projected as image 41 as it is and virtual image 42 is formed (step S104), and the processing ends. Note that the end of processing here is the end of processing for one original image. In practice, original images are transmitted successively, and therefore successive projection is still being performed.

When the projection position of an original image is outside the predetermined angle of view if the original image is projected (Yes in step S103), an adjustment is made to change the projection position by the amount of change according to the superimposition distance based on Equation (1) described above, and image 41 to which the change is applied is generated (step S105). Then, the processing proceeds to step S104, image 41 to which the change is applied is projected and virtual image 42 is formed, and the processing ends.

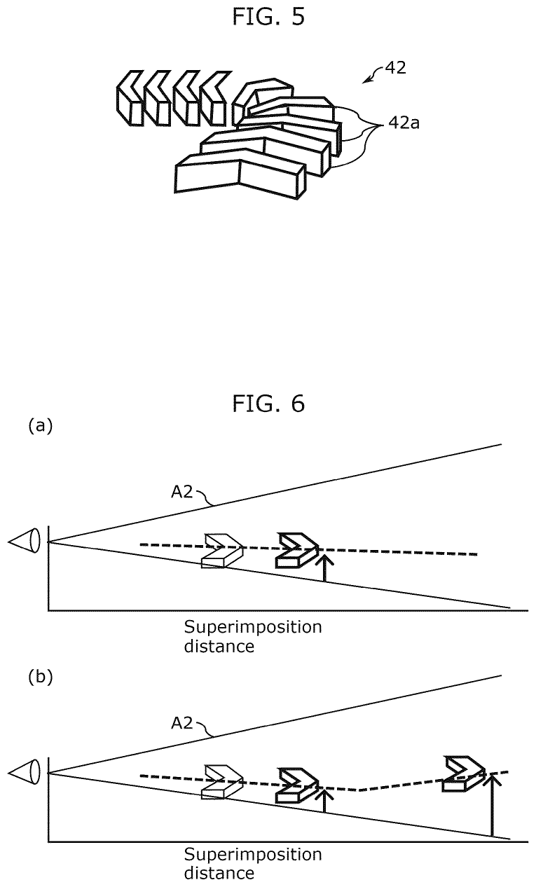

There may be cases where an image may include a plurality of partial images that form a plurality of partial virtual images 42a, as illustrated in FIG. 5. For the original image including such partial images, the determination in step S103 is performed for each partial image. In other words, whether the projection position is outside the predetermined angle of view is determined for each partial image, and only for a partial image outside the predetermined angle of view, the adjustment in step S105 is performed to change the projection position. When a plurality of partial images are included in one original image, the difference in distance between the partial images becomes imperceptible, especially as illustrated in (a) in FIG. 3, and therefore the effect of the present embodiment to reduce the loss of information of the superimposition distance tends to manifest.

Moreover, as shown in Equation (1) above, although the equation indicating the amount of change is calculated as a linear function proportional to the superimposition distance, the amount of change may be calculated to perform adjustment as illustrated in FIG. 6. Specifically, in FIG. 6, (a) is a figure essentially the same as (b) in FIG. 3, and (b) illustrates a different variation of (b) in FIG. 3. As illustrated in (b) in FIG. 6, the equation indicating the amount of change need not be a linear function, and may be a conditional expression in which the superimposition distance is divided into separate cases by a predetermined distance, or quadratic or higher-order functions. This has an advantage of making it easier to display an image that forms a distant virtual image 42 whose information of the superimposition distance is easily lost.

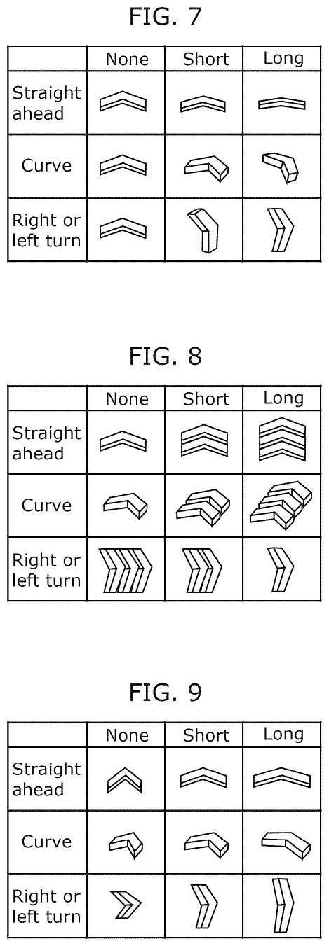

Controller 13 can also adjust images based on the driving situation as illustrated in FIGS. 7 to 12, which will be described below. In FIGS. 7 to 10, the lengths of the respective deviation distances are illustrated in columns 2 to 4, and the road situations at superimposition destinations estimated according to the driving situations are illustrated in rows 2 to 4. Each road situation at the superimposition destination estimated from a driving situation is selected as one of “straight ahead”, “curve”, or “right or left turn”. For example, when the driving situation is shown in an image captured by an in-vehicle camera, it is possible to estimate whether the superimposition destination of virtual image 42 is “straight ahead”, “curve”, or “right or left turn” by analyzing the image. Alternatively, when the driving situation is a route to the destination obtained from the car navigation system and the location of the vehicle, it is possible to estimate whether the superimposition destination on the route from the location of the vehicle is “straight ahead”, “curve”, or “right or left turn”.

The image can then be adjusted according to whether the superimposition destination is “straight ahead”, “curve”, or “right or left turn” and whether the deviation distance is “none”, “short”, or “long”. Note that pre-set thresholds (for example, 0 m for “none”, 0.3 m to 0.7 m for “short”, 0.7 m or greater for “long”, and so on) are used to determine whether the deviation distance is any one of none, short, or long. Alternatively, the image can be adjusted by continuously changing the image using a function of the length of the deviation distance, regardless of the thresholds. Note that, when the superimposition destination is “curve” or “right or left turn”, the position at which the image is superposed may deviate in the right-and-left direction. In such a case, the superimposition position may be adjusted in the right-and-left direction based on the road situation.

For example, setter 32 can be used to set various adjustments on and off in the following description, as well as to set the degree of adjustments to be made. In other words, setter 32 has a function of receiving settings of on and off of the adjustment of the original image using the driving situation and settings of parameters.

As illustrated in FIG. 7, for example, the display angle of an image can be rotated by one of a yaw angle, a roll angle, or a pitch angle based on the driving situation and the deviation distance. At this time, it is sufficient to change the rotation angle so that the rotation angle correlates with the deviation distance corresponding to the superimposition distance associated with the original image. Specifically, if the driving situation is “straight ahead”, the pitch angle rotates by the rotation angle according to the deviation distance, if the driving situation is “curve”, the yaw angle rotates at the rotation angle according to the deviation distance, and if the driving situation is “right or left turn”, the roll angle rotates by the rotation angle according to the deviation distance.

Moreover, as illustrated in FIG. 8, for example, the total number of images (the total number of replications) can be changed by replicating an image based on the driving situation and the deviation distance. Here, it is sufficient to change the total number of replications to correlate with the deviation distance corresponding to the superimposition distance associated with the original image, and replicate the image by the total number of replications. Note that the numbers of replications illustrated in FIG. 8 are mere examples, and whether to increase or decrease the number of replications with an increase in deviation distance may be appropriately set.

Moreover, as illustrated in FIG. 9, the shape of an image can be changed based on the driving situation and the deviation distance, for example. For example, in the figure, each image can be regarded as a substantially triangular shape that fits within a range defined by a first direction and a second direction from a predetermined point, and the second direction is different from the first direction. The angle formed by the first direction and the second direction can be changed to rescale the substantially triangular shape based on the degree of spread from the vertex such that the substantially triangular shape correlates with the superimposition distance associated with the original image and the corresponding deviation distance. Note that the changes in angle illustrated in FIG. 9 are mere examples, and whether to increase or decrease the angle formed by the first direction and the second direction with an increase in deviation distance may be appropriately set.

Moreover, as illustrated in FIG. 10, for example, the size of an image can be changed based on the driving situation and the deviation distance. Here, it is sufficient to change the scale factor that correlates with the deviation distance corresponding to the superimposition distance associated with the original image, and rescale the image by the changed scale factor. Note that the changes in scale factor illustrated in FIG. 10 are mere examples, and whether to increase or decrease the scale factor with an increase in deviation distance may be appropriately set.

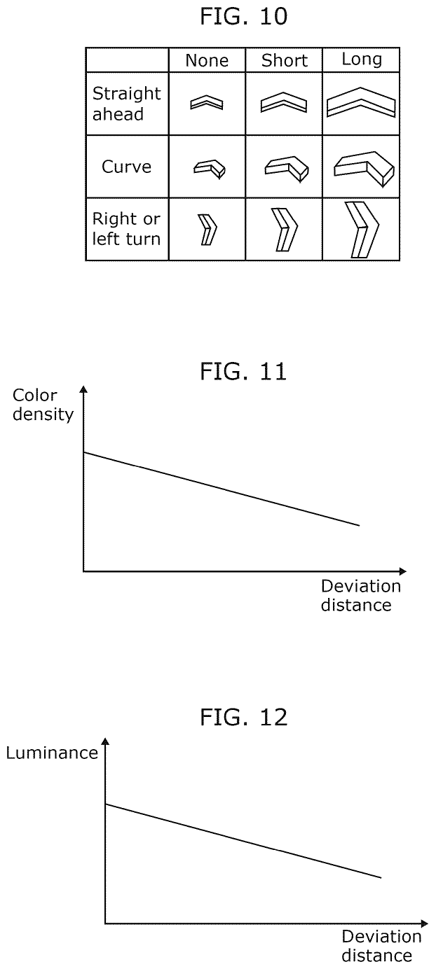

Moreover, FIGS. 11 and 12 show the changes in display color and luminance with respect to the deviation distance.

As shown in FIG. 11, the color density can be adjusted to decrease with an increase in deviation distance, as an example of the displayed color. Conversely, the color density may be increased with an increase in the deviation distance. Moreover, the hue may be changed as an adjustment of the display color according to the deviation distance.

Moreover, as illustrated in FIG. 12, the luminance may be adjusted to decrease with an increase in the deviation distance. Conversely, the luminance may be increased with an increase in the deviation distance.

As described above, the generated image 41 is adjusted based on the driving situation and the superimposition distance (in particular, the deviation distance corresponding to the superimposition distance), and is projected by projector 21 to form an appropriate virtual image 42. As described above, in the present embodiment, image 41 can be displayed appropriately based on the driving situation and the superimposition distance (in particular, the deviation distance corresponding to the superimposition distance) such that information corresponding the driving situation and the superimposition distance is less likely to be lost. Note that, regarding the adjustment of the image based on the driving situation and the superimposition distance described above, only one adjustment may be implemented, one or more combinations of two or more adjustments may be implemented, or need not be implemented.

### Advantageous Effects, Etc.

As described above, display device 100 according to a first aspect is display device 100 that forms virtual image 42 of image 41 visible to user 51 in predetermined region A2 in an outside world by projecting the image within a predetermined angle of view (display region A1) of display medium 34 through which the outside world is viewable, predetermined region A2 corresponding to the predetermined angle of view. Display device 100 includes: projector 21 that projects light showing image 41 onto display medium 34; an obtainer (first obtainer 11) that obtains a superimposition distance that is a distance from user 51 to a position at which virtual image 42 of image 41 is formed; and controller 13 that, when an original projection position of image 41 is outside the predetermined angle of view, changes the original projection position of image 41 by an amount of change corresponding to the superimposition distance and causes projector 21 to project image 41.

Such display device 100 can be adjusted to change the projection position such that image 41 fits within the predetermined angle of view. When changing the projection position, the projection position of image 41 is changed by the amount of change corresponding to the superimposition distance, and therefore information of the superimposition distance can be read from the amount of change. In other words, information that will be lost due to adjustments can be maintained to avoid losing the information. As described above, it is possible to display an image more appropriately in terms of addressing the loss of information.

Moreover, for example, display device 100 according to a second aspect is display device 100 according to the first aspect. Image 41 includes a plurality of partial images, the superimposition distance includes a partial superimposition distance of each of the plurality of partial images, and controller 13 changes, by an amount of change corresponding to the partial superimposition distance of each of the plurality of partial images, a projection position of each of the plurality of partial images whose original projection positions are outside the predetermined angle of view, and causes projector 21 to project the partial images.

This makes it possible to make adjustments to partially change the projection position of the partial image whose original projection position is outside the predetermined angle of view in image 41 including a plurality of partial images.

Moreover, for example, display device 100 according to a third aspect is display device 100 according to the first or second aspect, and controller 13 further changes a display angle of image 41 by an angle corresponding to the superimposition distance and causes projector 21 to project image 41 changed.

This makes it possible to change the display angle of image 41 by an angle corresponding to the superimposition distance and cause projector 21 to project the changed image 41.

Moreover, for example, display device 100 according to a fourth aspect is display device 100 according to any one of the first to third aspects, and controller 13 further replicates image 41 by a total number of replications corresponding to the superimposition distance and causes projector 21 to project replicated images 41.

This makes it possible to replicate the image by the total number of replications corresponding to the superimposition distance and causes projector 21 to project replicated images 41.

Moreover, for example, display device 100 according to a fifth aspect is display device 100 according to any one of the first to fourth aspects, and image 41 fits within a range defined by a first direction and a second direction from a predetermined point, the second direction being different from the first direction; and controller 13 further changes an angle formed by the first direction and the second direction by an angle corresponding to the superimposition distance and causes projector 21 to project image 41 changed.

This makes it possible to change the angle formed by the first direction and the second direction by an angle corresponding to the superimposition distance and cause projector 21 to project the changed image 41.

Moreover, for example, display device 100 according to a sixth aspect is display device 100 according to any one of the first to fifth aspects, and controller 13 further rescales image 41 by a number of scale factors corresponding to the superimposition distance and causes projector 21 to project image 41 rescaled.

This makes it possible to rescale the image by the number of scale factors corresponding to the superimposition distance and causes projector 21 to project the rescaled image 41.

Moreover, for example, display device 100 according to a seventh aspect is display device 100 according to any one of the first to sixth aspects, and controller 13 further changes a display color of image 41 by an amount of change corresponding to the superimposition distance and causes projector 21 to project image 41 changed.

This makes it possible to change the display color of image 41 by an amount of change corresponding to the superimposition distance and cause projector 21 to project the changed image 41.

Moreover, for example, display device 100 according to an eighth aspect is display device 100 according to any one of the first to seventh aspects, and controller 13 further changes a luminance of image 41 by an amount of change corresponding to the superimposition distance and causes projector 21 to project image 41 changed.

This makes it possible to change the luminance of image 41 by an amount of change corresponding to the superimposition distance and cause projector 21 to project the changed image 41.

Moreover, a display method according to a ninth aspect is a display method to be executed by a computer and for forming virtual image 42 of image 41 visible to user 51 in predetermined region A2 in an outside world by projecting image 41 within a predetermined angle of view (display region A1) of display medium 34 through which the outside world is viewable, predetermined region A2 corresponding to the predetermined angle of view. The display method includes: projecting light showing image 41 onto display medium 34 (step S104); obtaining a superimposition distance that is a distance from user 51 to a position at which virtual image 42 of image 41 is formed (first obtaining step S101); and changing, when an original projection position of image 41 is outside the predetermined angle of view, the original projection position of image 41 by an amount of change corresponding to the superimposition distance (step S105).

This produces the same advantageous effects as those described above for display device 100.

Moreover, a recording medium according to a tenth aspect is a non-transitory computer-readable recording medium having recorded thereon a program for causing a computer to execute the display method according to the ninth aspect.

This produces the same advantageous effects as those described above for display device 100 with use of a computer.

### Other Embodiments

The display device and so on according to the present disclosure have been described above on the basis of the embodiment, but the present disclosure is not limited to this embodiment.

Moreover, although an exemplary use of the display device has been described as being used in combination with a plurality of external devices in the above embodiment, the display device may be implemented as a single device including these external devices. For example, the display device integrated with the display medium may be implemented, the display device integrated with the imager may be implemented, the display device integrated with the ECU may be implemented, and the display device integrated with other functional components may be implemented. Moreover, the plurality of structural elements included in the display device according to the above embodiment may be respectively implemented by individual devices. When the display device is implemented by a plurality of devices, the structural elements of the display device may be distributed in any manner to the plurality of devices.

Moreover, in the above embodiment, the processing performed by a specific processing unit may be performed by another processing unit. Moreover, the order of a plurality of processes may be changed, or a plurality of processes may be executed in parallel. Moreover, in the above embodiment, the examples of operation may be combined in any manner. In the above embodiment, examples of corrections of a plurality of original images have been described, but examples of corrections combining these examples of corrections are also included in the present disclosure, for example.

In the above embodiment, an example in which a windshield of a vehicle is applied as a display medium has been described, but the display medium may be implemented as a member dedicated to the display device such as a combiner. In addition, one or more lenses of a user-wearable device of an eyeglass type may be applied as a display medium. Moreover, the vehicle described in the above embodiment has been described as a four-wheeled vehicle, etc. with a passenger compartment, but the vehicle may be a two-wheeled vehicle without a passenger compartment. In this case, for example, a meter visor or a windshield provided to a helmet can be used as a display medium. Moreover, the above-mentioned vehicle is a concept that includes a simulator for simulating the operation of a vehicle by means of a display, etc.

Moreover, in the above embodiment, each of the structural elements may be implemented by executing an appropriate software program for each structural element. Each structural element may be implemented as a result of a program executer such as a central processing unit (CPU) or processor reading and executing a software program recorded on a recording medium such as a hard disk or semiconductor memory.

Moreover, each structural element may be implemented by hardware. For example, each structural element may be a circuit (or integrated circuit). These circuits may form a single circuit as a whole, or may be separate circuits. Moreover, each of these circuits may be a general-purpose circuit or a dedicated circuit.

Moreover, the general or specific aspects of the present disclosure may be implemented using a system, a device, a method, an integrated circuit, a computer program, a recording medium such as a compact disc-read only memory (CD-ROM). Moreover, the general or specific aspects of the present disclosure may be implemented using any combination of systems, devices, methods, integrated circuits, computer programs, and recording media.

For example, the present disclosure may be implemented as a display method to be executed by a computer, or as a program for causing a computer to execute such a display method. Moreover, the present disclosure may be implemented as a non-transitory computer-readable recording medium having recorded thereon such a program.

In addition, embodiments obtained by applying various modifications, which occur to those skilled in the art, to the aforementioned embodiments, and embodiments obtained by combining the structural elements and functions in the aforementioned embodiments in any manner within a scope not departing from the teaching of the present disclosure are also included in the present disclosure.

While various embodiments have been described herein above, it is to be appreciated that various changes in form and detail may be made without departing from the spirit and scope of the present disclosure as presently or hereafter claimed.

### Further Information About Technical Background to This Application

The disclosure of the following patent application including specification, drawings, and claims is incorporated herein by reference in their entirety: Japanese Patent Application No. 2023-223511 filed on Dec. 28, 2023.

### INDUSTRIAL APPLICABILITY

The present disclosure is useful as a display device that allows a user such as a driver to see images showing various information as virtual images that are superimposed on the scenery of the outside world.

1. A display device that forms a virtual image of an image visible to a user in a predetermined region in an outside world by projecting the image within a predetermined angle of view of a display medium through which the outside world is viewable, the predetermined region corresponding to the predetermined angle of view, the display device comprising:
a projector that projects light showing the image onto the display medium;
an obtainer that obtains a superimposition distance that is a distance from the user to a position at which the virtual image of the image is formed; and
a controller that, when an original projection position of the image is outside the predetermined angle of view, changes the original projection position of the image by an amount of change corresponding to the superimposition distance and causes the projector to project the image.

2. The display device according to claim 1, wherein
the image includes a plurality of partial images,
the superimposition distance includes a partial superimposition distance of each of the plurality of partial images, and
the controller changes, by an amount of change corresponding to the partial superimposition distance of each of the plurality of partial images, a projection position of each of the plurality of partial images whose original projection positions are outside the predetermined angle of view, and causes the projector to project the partial images.

3. The display device according to claim 1, wherein
the controller further changes a display angle of the image by an angle corresponding to the superimposition distance and causes the projector to project the image changed.

4. The display device according to claim 1, wherein
the controller further replicates the image by a total number of replications corresponding to the superimposition distance and causes the projector to project replicated images.

5. The display device according to claim 1, wherein
the image fits within a range defined by a first direction and a second direction from a predetermined point, the second direction being different from the first direction; and
the controller further changes an angle formed by the first direction and the second direction by an angle corresponding to the superimposition distance and causes the projector to project the image changed.

6. The display device according to claim 1, wherein
the controller further rescales the image by a total number of scale factors corresponding to the superimposition distance and causes the projector to project the image rescaled.

7. The display device according to claim 1, wherein
the controller further changes a display color of the image by the amount of change corresponding to the superimposition distance and causes the projector to project the image changed.

8. The display device according to claim 1, wherein
the controller further changes a luminance of the image by the amount of change corresponding to the superimposition distance and causes the projector to project the image changed.

9. A display method to be executed by a computer and for forming a virtual image of an image visible to a user in a predetermined region in an outside world by projecting the image within a predetermined angle of view of a display medium through which the outside world is viewable, the predetermined region corresponding to the predetermined angle of view, the display method comprising:
projecting light showing the image onto the display medium;
obtaining a superimposition distance that is a distance from the user to a position at which the virtual image of the image is formed; and
changing, when an original projection position of the image is outside the predetermined angle of view, the original projection position of the image by an amount of change corresponding to the superimposition distance.

10. A non-transitory computer-readable recording medium having recorded thereon a program for causing a computer to execute the display method according to claim 9.
